(19) United States
(12) Patent Application Publication
(10) Pub. No.: US 2007/0040375 A1
(43) Pub. Date: Feb. 22, 2007

(54) LOCATING APPLIANCE FOR A NON-METALLIC PIPING MEMBER

(76) Inventor: Raymond V. FIERST, Broadview Heights, OH (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/465,423

(22) Filed: Aug. 17, 2006

Related U.S. Application Data
(60) Provisional application No. 60/708,891, filed on Aug. 17, 2005.

(51) Int. Cl. F16L 55/00

(52) U.S. Cl. 285/93; 285/901

(57) ABSTRACT

A locating appliance provides expedite locating of non-metallic pipes. The locating appliance is employed with an existing tight seal plug inherent to a non-metallic pipe and includes a metal disk engaged with a self-taping screw. The locating appliance is installed by suitably screwing it into an end cap of the existing tight seal plug. Alternatively, a locating plug including a metal disk affixed with the end cap of the plug, is designed to be installed instead of the existing tight seal plug inherent to the non-metallic pipe. When a user has a need to access the pipe, such as for replacement purposes, to clear a sewer line, or the like, the user is able to quickly and accurately locate the locating appliance, or the locating plug using any suitable metal detector or device known in the art.

### CROSS-REFERENCE TO RELATED APPLICATIONS

This application is based on and claims priority to provisional U.S. patent application Ser. No. 60/708,891, which was filed on Aug. 17, 2005.

### BACKGROUND OF THE INVENTION

This invention is directed to piping systems. More particularly, the present invention is directed to a locating appliance for a non-metallic piping member and a locating end fitting for a piping member for use in various plumbing and piping situations, such as piping repair, replacement, plumbing, and the like.

Use of PVC and other non-metallic piping has become prevalent in indoor/outdoor applications. However, when used in external applications, the non-metallic pipes are either buried, or gradually sink into the ground without routine maintenance. Once the piping gets covered by earth or other building materials, it is difficult to determine the exact location when problems occur. For example, when a non-metallic pipe ruptures under concrete or other aggregate, frequently the only way to determine the location is to begin digging where fluid is visible. This may result in a large undertaking to ascertain the location. In many cases, large tracts of sod, dirt, and plants must be moved to determine where the non-metallic pipe, such as a sewer pipe, is located. In addition, non-metallic sewer pipes are typically plugged with threaded caps of the same material as the pipe itself. When covered with earth, this sewer pipe is not easily located.

Thus, there is a need for an appliance that provides locating of non-metallic piping systems, specifically, outdoor piping systems.

There also exists a need for an appliance that provides easy access to non-metallic outdoor piping systems, such as sewer pipes.

### SUMMARY OF INVENTION

In view of the aforementioned needs, there is contemplated an appliance that provides locating of non-metallic piping systems, specifically, outdoor piping systems.

In accordance with the subject application, there is provided an appliance that allows for easy access to non-metallic outdoor piping systems, such as sewer pipes.

In accordance with one aspect of the subject application, there is provided a locating appliance for a non-metallic piping member including a plate member adapted for being engaged with an associated end fitting for a non-metallic piping member. The plate member is, at least partially, a metal plate member, and is further adapted for being located by a metal detector.

In a preferred embodiment, the locating appliance further includes a screw member. In this embodiment the plate member further includes an opening adapted for receiving the screw member. Preferably, the screw member is of a self-tapping type and is further adapted for engaging the plate member with an associated end fitting for a non-metallic piping member.

In another preferred embodiment, the locating appliance includes a gasket member. The gasket member includes an opening adapted for receiving the screw member and is placed between the plate member and an associated end fitting for a non-metallic piping member such that the opening in the gasket member is coaxial with the opening in the plate member. The gasket member is, preferably, made of resilient material. The plate member is, advantageously, of a disk shape and includes a suitable protective coating.

In accordance with another aspect of the subject application, there is provided a locating plug for a non-metallic piping member including a cylinder part adapted for being received by an associated respective piping member and an end cap part fixedly attached to the cylinder part. The end cap part at least partially overlaps the cylinder part. The cylinder part is further adapted for being engaged by an interior of an associated respective piping member. The end cap part includes at least one metal portion adapted for being located by a metal detector. The diameter of the cylinder part is suitably adapted to standard pipe member sizes.

In one embodiment, the end cap part further includes a top surface and a bottom surface, and wherein the bottom surface of the end cap part is fixedly attached to the cylinder part. The at least one metal portion is, preferably, a metal disk. The metal disk is capable of being fixedly attached to the top surface of the end cap part. Alternatively, the metal disk is capable of being embedded into the top surface of the end cap part.

In a preferred embodiment, the locating plug further includes at least one gasket, wherein the gasket envelopes the cylinder part. The at least one gasket is, preferably, made of a resilient material.

The cylinder part, preferably, includes at least one annular groove, wherein the at least one gasket is placed in the at least one annular groove. The cross section of the at least one gasket is, preferably, one of an O-shape, and V-shape.

Still other advantages, aspects and features of the present invention will become readily apparent to those skilled in the art from the following description wherein there are shown and described preferred embodiments of this invention, simply by way of illustration of the best modes best suited for carrying out the invention. As it will be realized, the invention is capable of other different embodiments and its several details are capable of modifications in various obvious aspects all without departing from the scope of the invention. Accordingly, the drawings and description will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1a illustrates a top view of a locating appliance for a non-metallic piping member in accordance with the present invention;

FIG. 1b illustrates a side view of the locating appliance for a non-metallic piping member in accordance with the present invention;

FIG. 2a illustrates a cross-section view of a locating plug engaged with a pipe in accordance with the present invention; and

FIG. 2b illustrates a top view of the locating plug in accordance with the present invention.

### DETAILED DESCRIPTION OF THE PREFERRED EMBODIMENTS

The present invention is directed to piping systems. More particularly, the present invention is directed to a locating appliance for a non-metallic piping member and a locating end fitting for a piping member for use in various plumbing and piping situations, such as piping repair, replacement, plumbing, and the like. Those skilled in the art will appreciate that the subject invention is not limited to the use of any single dimension non-metallic pipe. As will be known in the art, suitable pipe dimensions include, but are not limited to, SDR-35, PVC, ASTM D-30 34, 4″, 6″, 8″ pipe and the like.

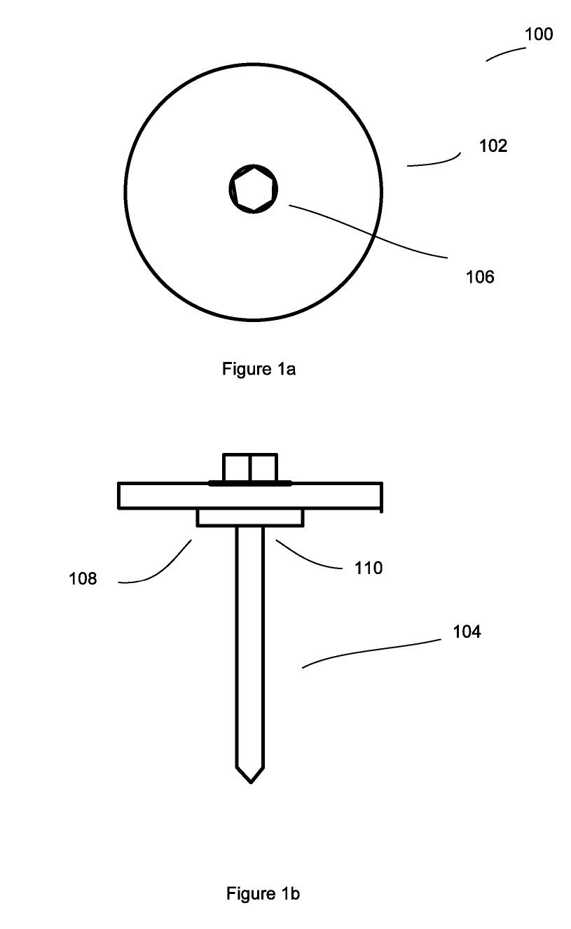

Referring now to FIG. 1, there is shown a preferred embodiment of the locating appliance 100 for a non-metallic piping member (not shown in the drawing). As will be understood by a skilled artisan, FIG. 1 illustrates a top view of the locating appliance 100, whereas FIG. 1b illustrates a side view of the locating appliance 100 in accordance with the present invention. The locating appliance 100 includes a plate member, preferably, shaped as a disk and illustrated in FIG. 1 as a disk 102. The disk 102 is capable of being engaged with an end fitting for a piping member, for example and without limitation, with an end cap of a non-metallic plug (not shown in FIG. 1) inherent to a non-metallic piping member. The disk 102 is, at least partially, a metal disk, and is further adapted for being located by a metal detector (not shown). As will be recognized by those skilled in the art, the disk 102 is suitably fabricated from any material capable of detection by a metal detector, such as for example and without limitation, bronze, steel, iron, brass, and the like. It will further be appreciated by those skilled in the art that, preferably, the material of the disk 102 be suitably protected from external exposure so as to prevent degradation to the disk 102 from such exposure. Suitable materials, such as zinc and the like, and methods for protecting metal are well-known in the art, and any such material and method is capable of being employed to protect the exposed metal of the disk 102.

The locating appliance 100 as depicted in FIG. 1 includes a screw 104, which is preferably, of a self-taping type. The disk 102 includes an opening 106 adapted for receiving the screw 104. The screw 104 is adapted for engaging a non-metallic end fitting, such as an end fitting inherent to a non-metallic piping member. The locating appliance 100 suitably includes a gasket member 108. The gasket member 108 includes an opening 110 adapted for receiving the screw 104. As will be recognized by those skilled in the art, the gasket member 108 is adapted for being placed between the disk 102 and a non-metallic plug, such as one inherent to a non-metallic piping member, such that the opening 110 in the gasket member 108 is coaxial with the opening 106 in the disk 102. A skilled artisan will also appreciate that the gasket member 108 is, preferably, made of a resilient material, such as rubber, neoprene, and the like. Other suitable materials are equally capable of being employed by the present invention for fabricating the gasket member 108.

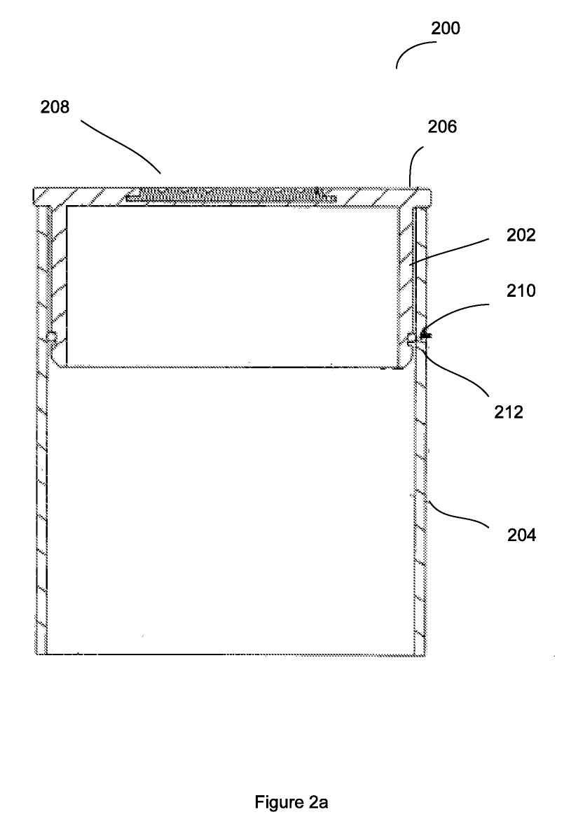

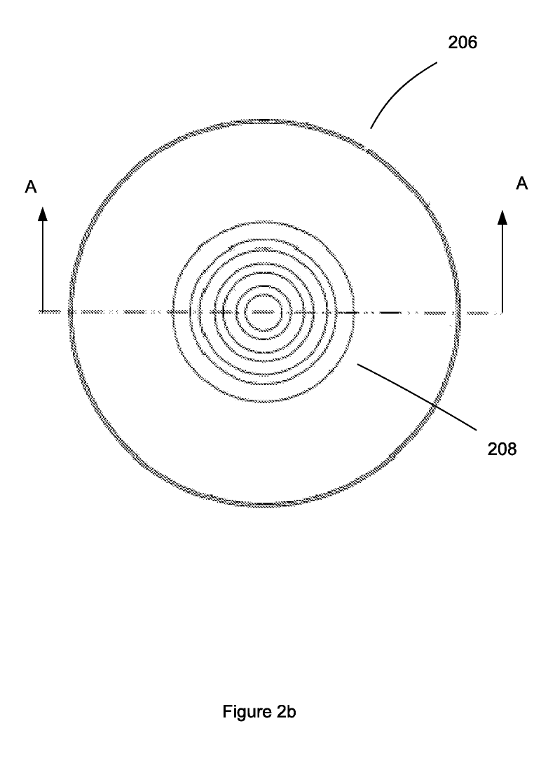

Referring now to FIG. 2a, there is shown a cross-section view of a preferred embodiment of the locating plug 200 in accordance with the present invention. As illustrated in FIG. 2a, the locating plug 200 includes a cylinder part 202 adapted for being received by a respective piping member 204, and an end cap part 206 fixedly attached to the cylinder part 202. The end cap part 206, as depicted in FIG. 2a, overlaps the cylinder part 202. The cylinder part 202 is further adapted for being engaged by an interior of the respective piping member 204. In the embodiment illustrated in FIG. 2a, the end cap part 206 includes a metal portion, preferably, of a disk shape. The metal portion is illustrated in FIG. 2a as a metal disk 208. Those skilled in the art will recognize that the metal disk 208 is capable of being fabricated from any material capable of detection by a metal detector, such as for example and without limitation, bronze, steel, iron, brass, and the like. In the embodiment of FIG. 2a, the metal disk 208 is embedded into the top surface of the end cap part 206.

A skilled artisan will appreciate that the diameter of the cylinder part 202 is suitably adapted to standard piping member sizes so as to suitably fit inside the inner diameter of the piping member 204. As will be understood by those skilled in the art, the piping member 204 is any suitable pipe as is known in the art, such as a non-metallic sewer pipe. It will be understood by those skilled in the art that the locator plug 200 is capable of being constructed of any suitable material known in the art, such as PVC, ceramic, and the like. Those skilled in the art will understand, that the end cap part 206 is suitably adapted to seat on the face of the piping member 204, so as to prevent unwanted material, such as debris, from entering the piping member 204.

It will further be appreciated by those skilled in the art that, preferably, the material of the disk 208 be suitably protected from external exposure so as to prevent degradation to the disk 208 from such exposure. Suitable materials and methods for protecting metal are well-known in the art, and any such method is capable of being employed to protect the exposed metal of the disk 208.

The embodiment of the locating plug shown in FIG. 2a, includes a gasket 210 that envelopes the cylinder part 202. The gasket 210 is, preferably, made of a resilient material, such as rubber and the like, and is placed in an annular groove 212. The cross section of the gasket 210 is, preferably, one of an O-shape, and V-shape.

FIG. 2b illustrates a top view of the locator plug 200 showing the relative positions of the metal disk 208 to the end cap part 206.

As will be apparent to those skilled in the art, when suitably employed, the present invention enables a user, such as utility maintenance personnel, homeowners, and the like, to quickly and accurately locate covered sewer pipes and the like, without requiring large excavations.

In accordance with one aspect of the present invention, a user employs the locating appliance 100 illustrated in FIG. 1, on a sewer pipe, sprinkler system, and the like, during installation or when the pipe is uncovered by dirt, aggregate, or the like. A skilled artisan will appreciate, that the locating appliance is capable of being employed without removing the tight seal plug inherent to the non-metallic piping member. For installation, a suitable hole or opening is suitably made, such as drilled, in a top portion of a tight seal plug inherent to the non-metallic pipe. Following, the self-taping screw 104 is simply screwed into a top portion of the tight seal plug. The pipe is then able to be covered by dirt, aggregate, or the like. At some point in the future, when the user has a need or desire to access the pipe, such as for replacement purposes, to clear a sewer line, or the like, the user is able to quickly and accurately locate the locating appliance 100 using any suitable metal detector or device known in the art capable of detecting metallic objects. A skilled artisan will appreciate, that the locating appliance 100 is equally capable of being installed into an end fitting before the latter is engaged with a respective pipe to provide in future locating of respective piping by means of a metal detector, or the like.

In accordance with another aspect of the present invention, a user similarly employs the locating plug 200, illustrated in FIG. 2, on a sewer pipe, sprinkler system, and the like, during installation or when the pipe is uncovered by dirt, aggregate, or the like. A skilled artisan will appreciate, that alternative to the embodiment described above, to install the locating plug 200, the tight seal plug inherent to the non-metallic pipe 204 is first removed. Next, the locating plug 200 is installed instead of the initial plug. The gasket 210 enables a tight seal, thereby enclosing the interior of the pipe 204 and protecting the contents from contamination, moisture, and the like. The pipe 204 is then able to be covered by dirt, aggregate, or the like. At some point in the future, when the user has a need or desire to access the pipe, such as for replacement purposes, to clear a sewer line, or the like, the user is able to quickly and accurately locate the locating plug 200, using any suitable metal detector or device known in the art capable of detecting metallic objects, similarly to locating the locating appliance 100, as described above.

The foregoing description of preferred embodiments of the invention has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A locating appliance for a non-metallic piping member comprising:
a plate member adapted for being engaged with an associated end fitting for a non-metallic piping member;
wherein the plate member is, at least partially, a metal plate member, and is further adapted for being located by a metal detector.

2. A locating appliance for a non-metallic piping member of claim 1 further comprising a screw member, wherein the plate member further comprises an opening adapted for receiving the screw member.

3. A locating appliance for a non-metallic piping member of claim 2 wherein the screw member is of a self-tapping type, and wherein the screw member is adapted for engaging the plate member with an associated end fitting for a non-metallic piping member.

4. A locating appliance for a non-metallic piping member of claim 2 further comprising a gasket member, wherein the gasket member comprises an opening adapted for receiving the screw member, and wherein the gasket member is placed between the plate member and an end fitting for a non-metallic piping member such that the opening in the gasket member is coaxial with the opening in the plate member.

5. A locating appliance for a non-metallic piping member of claim 4 wherein the gasket member is of resilient material.

6. A locating appliance for a non-metallic piping member of claim 1 wherein the plate member is of a disk shape.

7. A locating appliance for a non-metallic piping member of claim 1 wherein the plate member further includes a protective coating.

8. A locating plug for a non-metallic piping member comprising:
a cylinder part adapted for being received by an associated respective piping member; and
an end cap part fixedly attached to the cylinder part, the end cap part at least partially overlapping the cylinder part;
wherein the cylinder part is further adapted for being engaged by an interior of an associated respective piping member; and
wherein the end cap part includes at least one metal portion adapted for being located by a metal detector.

9. A locating plug for a piping member of claim 8 wherein the end cap part further comprises a top surface and a bottom surface, and wherein the bottom surface of the end cap part is fixedly attached to the cylinder part.

10. A locating plug for a pipe member of claim 9 wherein the at least one metal portion is a metal disk.

11. A locating plug for a piping member of claim 10 wherein the metal disk is fixedly attached to the top surface of the end cap part.

12. A locating plug for a piping member of claim 10 wherein the metal disk is embedded into the top surface of the end cap part.

13. A locating plug for a piping member of claim 8 further comprising at least one gasket, wherein the gasket envelopes the cylinder part.

14. A locating plug for a piping member of claim 13 wherein the cylinder part further comprises at least one annular groove, and wherein the at least one gasket is placed in the at least one annular groove.

15. A locating plug for a piping member of claim 13 wherein the cross section of the at least one gasket is one of an O-shape, and V-shape.

16. A locating plug for a piping member of claim 8 wherein the diameter of the cylinder part is adapted to standard pipe member sizes.

17. A locating plug for a piping member of claim 13 wherein the at least one gasket is made of a resilient material.
